(19) United States
(12) Patent Application Publication
(10) Pub. No.: US 2026/0163876 A1
(43) Pub. Date: Jun. 11, 2026

(54) INTEGRATION OF PRIVACY PRESERVING ALTERNATIVES FOR HANDLING OF THIRD-PARTY COOKIES IN PLATFORM AS SERVICE ENVIRONMENTS

(71) Applicant: SAP SE, Walldorf (DE)

(72) Inventors: Christof Momm, Dresden (DE); Niklas Albers, Heidelberg (DE); Achim Braemer, Heidelberg (DE)

(21) Appl. No.: 18/972,086

(22) Filed: Dec. 6, 2024

(51) Int. Cl. H04L 9/40

(52) U.S. Cl. CPC H04L 63/0815

(57) ABSTRACT

The disclosure generally describes methods, software, and systems for request processing. An authentication request to access applications provided as a service is received during a single sign-on session. A cookie processing request for cookies corresponding to the session is processed. A storage access header of the authentication request is processed. The storage access header includes the browser's storage access permissions. The storage access permissions are used to determine storage access issues related to the cookies that prevent cross-application tracking. A partition key is used to generate new partitioned cookies for activating storage access. A conflict between the new partitioned cookies and previously stored cookies is identified. The previously stored cookies are removed to resolve the conflict. A response to the authentication request is provided using the new partitioned cookies to access the applications.

### TECHNICAL FIELD

The present disclosure relates to privacy preservation. More particularly, implementations of the present disclosure are directed to computer-implemented methods, software, and systems for handling cookies to facilitate session requests in platforms as a service environment.

### BACKGROUND

Third-party cookies can be used to maintain user sessions and preferences across different applications provided as services. The third-party cookies can store authentication tokens that facilitate navigation between multiple applications provided as services, by single sign-on (SSO) systems, using the same authentication service. The authentication tokens can be used to automatically provide access to authorized applications, ensuring a seamless experience. However, continued functionality of authentication and interaction data storage can be dependent on user consent granted explicitly via a browser prompt. The user consent request and response processing can be controlled by an application programing interface gatekeeper. For example, the application programing interface gatekeeper can request user consent for each session or at set time intervals during the session increasing the complexity of the authentication service.

### SUMMARY

Implementations of the present disclosure are directed to techniques and tools for privacy preservation. More particularly, implementations of the present disclosure are directed to handling cookies to facilitate session requests in platforms as a service environment.

In some implementations, a method includes receiving an authentication request to access applications provided as a service during a single sign on session, the authentication request including a cookie processing request for cookies corresponding to the single sign on session, processing a storage access header of the authentication request, the storage access header including storage access permissions of a browser, determining, from the storage access permissions, storage access issues related to the cookies preventing cross-application tracking, partitioning the cookies, using a partition key, to generate new partitioned cookies for activating storage access, identifying a conflict between the new partitioned cookies and previously stored cookies, removing the previously stored cookies to resolve the conflict, and providing, a response to the authentication request to access the applications, using the new partitioned cookies.

The foregoing and other implementations can each optionally include one or more of the following features, alone or in combination. In particular, implementations can include all of the following features:

In some aspects, combinable with any of the previous aspects, determining, from the storage access permissions, storage access issues includes: determining that unpartitioned cookies are inaccessible to a fetch context lacking the storage access permissions, or determining that the fetch context includes the storage access permissions and is missing an access path to the unpartitioned cookies. The conflict between the new partitioned cookies and the previously stored cookies includes an endless login loop. The previously stored cookies include previously partitioned cookies or previously unpartitioned cookies. The previously partitioned cookies and previously unpartitioned cookies include same names. The previously stored cookies include stale cookies including an activated blocking status. The computer-implemented method further includes: in response to determining successful access the applications, deleting the new partitioned cookies.

Other implementations of the aspect include corresponding systems, apparatus, and computer programs, configured to perform the actions of the methods, encoded on computer storage devices.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

These and other implementations can each optionally include one or more of the following advantages. The described implementation provides a dynamically optimized cookie handling for session management. The described cookie handling is applicable to cookies having independent state mode and storage access header mode that advantageously facilitate single sign on sessions. The described approach is based on partitioning cookies, using a partition key, to generate new partitioned cookies for activating storage access to advantageously facilitate web dispatchers to effectively serve most client applications without requiring any changes visible on user end. As a result, an optimized preservation of compatibility can enhance continued functionality during a single sign on session. The identification of a conflict between the new partitioned cookies and previously stored cookies facilitates removal of previously stored cookies to resolve the conflict and facilitate data compatibility for optimizing access to applications. Another advantage of the described approach is that it includes identification of storage access issues related to the cookies preventing cross-application tracking to reduce authentication complexity and automatically provides authentication across applications.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the subject matter of the specification are set forth in the accompanying drawings and the description below. Other features, aspects, and advantages of the subject matter will become apparent from the description, the drawings, and the claims.

### DESCRIPTION OF DRAWINGS

FIG. 1 is a block diagram of an example system for handling cookies for session requests, according to some implementations of the present disclosure.

FIG. 2 is a block diagram of an example system architecture for handling cookies for session requests, according to some implementations of the disclosure.

FIG. 3A is a flowchart of an example process for handling cookies for single sign-on sessions, according to some implementations of the present disclosure.

FIG. 3B is a flowchart of an example process for handling cookies for unauthenticated requests, according to some implementations of the present disclosure.

FIG. 4 is a block diagram of an exemplary computer system used to provide computational functionalities associated with described algorithms, methods, functions, processes, flows, and procedures, according to some implementations of the present disclosure.

Like reference numbers and designations in the various drawings indicate like elements.

### DETAILED DESCRIPTION

Implementations of the present disclosure are directed to techniques and tools for privacy preservation. More particularly, implementations of the present disclosure are directed to handling cookies to facilitate session requests to access platforms providing applications as services. According to a HTTP protocol, server responses can include set cookie headers advising the browser to store a cookie for a particular domain. The stored cookies are included by the browser in requests to the domain. Cookies can be used for storing user preferences, tracking, and storing selected contents. In general, the stored cookies facilitate preservation of a state across multiple requests, including authentication requests. For example, during a single sign on session, platforms providing applications as services can receive an authentication request, from user devices authorized to access a set of applications. The authentication request can include a storage access header that defines storage access permissions of a browser. The storage access header of the authentication request can be processed to identify an optimal mode to handle the cookies compatible with the browser providing system, while preventing cross-application tracking.

Some browser providing systems are eliminating third-party cookies to prevent user tracking, which can be used for monitoring interaction-events. For use cases excluding monitoring of interaction-events, some privacy-preserving alternatives are available. One option is to use cookies having an independent state (CHIPS). Applying this option, third-party cookies can be stored using two keys, the host key and a new partition key. The partition key in this context facilitate segregation and management of cookies based on the origin of the request using an identified protocol and domain. The partition key helps ensure that cookies are only accessible within the context of the same origin, enhancing privacy and security by preventing cross-site tracking. CHIPS facilitates access to third-party content embedded across different subdomains of a site to access third-party cookies set by that content, but prevents cross-site tracking by introducing separate cookie jars using two keys instead of a single key.

Another privacy-preserving option is to use a gatekeeper application programming interface (API), known as a storage access API (SAA), specifically designed for use with inline frames (iframes). The gatekeeper API facilitates embedded content to access unpartitioned cookies. The SAA requires request and receipt of user consent, adding an extra layer of user interactions for user authentication and additional data communications between the browser providing system and the server system. Permission has to be granted explicitly via a browser prompt.

Another privacy-preserving option is to use storage access headers (SAH) as complements SAA 1) to support non-iFrame SAA use cases (e.g., credentialed cross-site fetch requests), and 2) to enable performance improvements of SAA in case a permission is already available. For platform-as-a-service (PaaS) conditions, the cookies are set by platform components (e.g., application servers, routers, reverse proxies, gateways), named web dispatchers, to control secure access to applications. Setting cookies by web dispatchers requires a more dynamic approach to overcome key challenges associated with the described privacy-preserving options.

A first challenge is related to the compatibility for non-blocking browsers. Activating cookie partitioning (CHIPS) restricts cookie access significantly, confining access to the embedded context only. Without CHIPS, cookies set with sameSite=None attribute are limitingly accessible across all embedded contexts, by disabling Same Site restrictions altogether, regardless of the browser. The limited access can be problematic for scenarios like Single Sign-On (SSO) cookies that need broader access. Predicting the impact of CHIPS is challenging due to the diversity of applications on the platform. If browsers are blocking cookies, CHIPS can be used despite potential breaks. If browsers are not blocking cookies, implementing CHIPS can introduce regressions.

A second challenge is related to stale cookies when transitioning to partitioned cookies. When migrating from unpartitioned to partitioned cookies, stale cookies in the browser cache can cause issues, especially if the browser fails to block third-party cookies (3PC). The leftover cookies can conflict with new partitioned cookies, triggering authentication issues. An example of an authentication issue within this context includes endless login loops. The server can receive two cookies (unpartitioned and partitioned) without being able to identify the partitioned one since cookie attributes are not included in requests to servers.

A third challenge is related to selective SAH support for non-iframe use cases. The web dispatchers can serve static content like cascading style sheets (CSS) files and facilitate access to Web APIs. Browsers can access the static content using JavaScript, for example, through a CSS link or a fetch request. When resources are protected, authentication usually relies on session cookies. In cross-site scenarios, the session cookies become third-party cookies that can be blocked by browsers. To support credentialed cross-site fetch or link requests, browsers are provided access to session cookies. Within this context, partitioned cookies are created and unpartitioned cookies are used to obtain storage access. If identity providers (IdPs) fail to support embeddings, partitioned cookies are not feasible and unpartitioned session cookies with storage access are used. For non-iframe scenarios, an SAH protocol can be implemented to acquire storage access. User devices accessing applications as platform customers can have different settings. The variation in the settings of the user devices raise issues in selecting a privacy-preserving option supported by a web dispatcher. A selection of the privacy preserving option enabled add a user device level implies altering all user devices. The described technologies provide a server-side solution that automatically selects the appropriate privacy-preserving method to dynamically optimize cookie handling for user devices requesting multi-application access within a single sign on session.

The system and processes described in the current disclosure present technologies for providing a CHIPS or SAH election mode to dynamically optimize cookie handling for user devices by applying the following options: cleaning up stale (partitioned or unpartitioned) cookies before proceeding with the request, partitioning cookies if needed (no storage access), not partitioning cookies if not needed (storage access available), and maintaining unpartitioned cookies and following the SAH protocol. The server-side solution enables web dispatchers to effectively serve most client applications without requiring any changes. For those few cases that this approach doesn't address, a manual override option is available. The described system provides authentication improvements based on the assumptions that browsers that send the storage access header also support CHIPS. Another advantage of the described approach is that a selector for cookie names is not required. User devices can avoid partitioning cookies by requesting storage access via the storage access API script. If storage access is available, cookies are not partitioned by the AUTO mode. The described implementations enable partitioning only when necessary. For session cookies used for authentication, an additional SAH protocol support can be included, without affecting other cookies. Clean-up is applied to all duplicate cookies, not just session cookies. The described approach is applicable to browser systems that provide access to storage access headers.

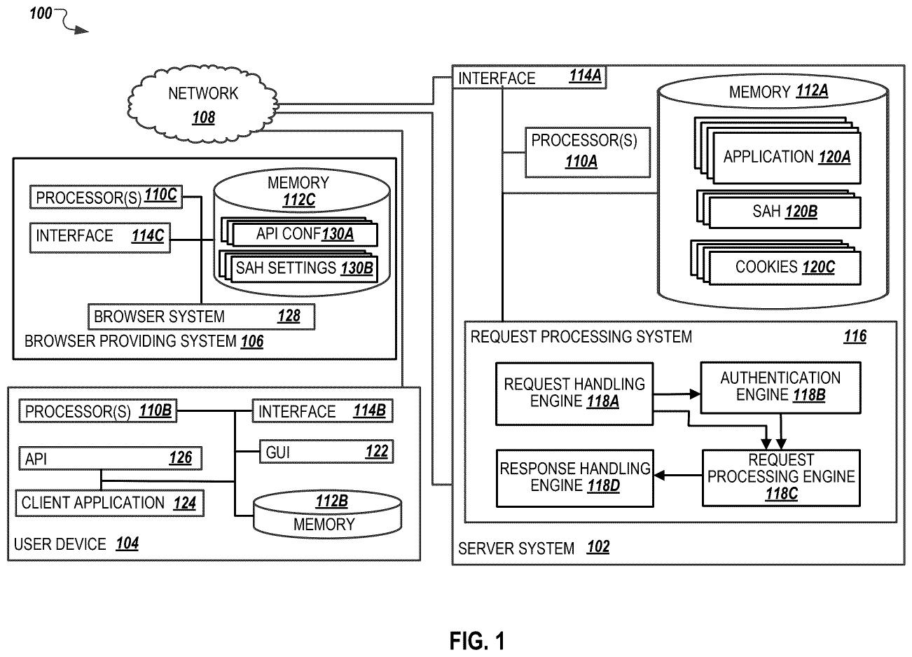

FIG. 1 is a block diagram illustrating an example system 100 for handling cookies for session requests, according to some implementations of the present disclosure. Specifically, the illustrated example system 100 includes or is communicably coupled with a server system 102, a user device 104, a browser providing system 106, and a network 108. Although shown separately, in some implementations, functionality of two or more systems or servers may be provided by a single system or server. In some implementations, the functionality of one illustrated system, server, or component may be provided by multiple systems, servers, or components, respectively.

In the example of FIG. 1, the server system 102 is intended to represent various forms of servers including, but not limited to a web server, an application server, a proxy server, a network server, and/or a server pool. In general, server systems 102 accept requests for application services including machine-learning training for handling cookies for single sign-on sessions services and provides such services to any number of user devices 104 (e.g., the user device 104 over the network 108). In accordance with implementations of the present disclosure, and as noted above, the server system 102 can host a solution environment that can be a cloud environment providing software applications, systems, and services that can be consumed by the user devices 104 as a service, within a single sign on session. In some instances, the server system 102 can support configuring of various tenants of different types, as well as services of different types that are integrated in customer integration scenarios and support execution of defined processes associated with handling cookies for single sign-on sessions. For example, the server system 102 includes a processor 110A, a memory 112A, an interface 114A, and an request processing system 116.

The request processing system 116 can include a request handling engine 118A, optionally, an authentication engine 118B, a request processing engine 118C, and a response handling engine 118D. The memory 112A can store applications 120A, SAH 120B, and cookies 120C. The request processing system 116 is coupled to the processor 110A, the memory 112A, and the interface 114A for handling cookies to enable access to the applications 120A (e.g., for single sign-on sessions) using the SAH 120B and the cookies 120C.

For example, user devices 104 generate requests to access the applications 120A as services that are received by the request processing system 116. The request can be processed by the request handling engine 118A of the request processing system 116 to access the header of the request. The authentication engine 116A can process the output of the request handling engine 118A to determine application-specific cookie headers for the single sign-on session. The request processing engine 118C can process the cookies 120C based on the storage access permissions. The response handling engine 118D can provide a response to the authentication request to access the applications 120A. One of the applications 120A (e.g., application A) can be accessed using cookie partitioning, while another application (e.g., application B) can be incompatible with cookie partitioning, requiring storage access that relies on a compatible authentication protocol to be provided by the request processing system 116.

In general, the user device 104 includes an electronic computer device operable to receive, transmit, process, and store any appropriate data associated with accessing application systems 120A provided as services by the server system 102. The user device 104 can encompass any client computing device such as a laptop/notebook computer, wireless data port, smart phone, personal data assistant (PDA), tablet computing device, one or more processors within these devices, or any other suitable processing device. The user device 104 includes an interface 114B, a processor 110B, a memory 112B, and a graphical user interface (GUIs) 122. The user device 104 can include one or more applications 124 that can be connected to or include an API 126. The application 124 can be any type of application (e.g., browsing application) that allows a user device to request and view content on the user device (e.g., generate a request to access the applications 120A). In some implementations, the application 124 can generate an authentication request to access the applications 120A that is transmitted over the network 108, to the request processing system 116 of the server system 102. In some instances, the application 124 can be an agent or client-side version of the one or more enterprise applications running on an enterprise server (not shown).

In accordance with implementations of the present disclosure, the application 124 includes a digital assistant that enables interactions between the user device 104, the browser providing system 106, and the server system 102. For example, and as described in further detail herein, the digital assistant of the user device 104 can receive a query. In some examples, one or more responses can include data that is presented as a graphical representation in the GUI 122. In accordance with implementations of the present disclosure, the digital assistant can present data as a graphical representation in a popover container within a window therein. In some examples, the popover container is provided as an iframe-based container and the digital assistant communicates with the popover container using remote procedure calls.

As described in further detail herein, a user can input a query to the digital assistant and the digital assistant can receive a response to the query. In accordance with implementations of the present disclosure, the response can include a seamless access to the applications 120A without requiring a single authentication (instead of multiple authentications) per session. In some examples, the graphical representation can be provided as a web-based rendering using a web rendering runtime that is built into the popover container (e.g., iframe). In some examples, the graphical representation is compatible with a UI framework of the popover container. An example UI framework includes, without limitation, SAPUI5 provided by SAP SE of Walldorf, Germany.

In some implementations, any or all of the components of the example system 100, both hardware or software (or a combination of hardware and software), may interface with each other or the interface(s) 114A, 114B, 114C (or a combination of multiple interfaces) over the network 108 for handling cookies for single sign-on sessions and unauthenticated request scenarios. The functionality of the user device 104 can be accessible for all service consumers using the application 124 that transmits prompts to the request processing system 116 to generate reports 118D.

For example, the user device 104 may include a computer that includes an input device, such as a keypad, touch screen, or other device that can accept user information, and an output device that conveys information associated with the operation of the server system 102, or the user device itself, including digital data, visual information, or a GUI 122, respectively. The GUI 122 can interface with at least a portion of the system 100 for any suitable purpose, including generating a visual representation of the application 124 or the applications 120A, respectively. In particular, the GUI 122 can be used to view and navigate various Web pages. The GUI 122 can provide the user with an efficient and user-friendly presentation of data provided by or communicated within the system. The GUI 122 can include a plurality of customizable frames or views having interactive fields, pull-down lists, and buttons operated by the user. The GUI 122 can include any suitable graphical user interface, such as a combination of a generic web browser, intelligent engine, and command line interface (CLI) that processes information and efficiently presents the results to the user visually.

The browser providing systems (and/or asset provider systems) 106 can include multiple systems that exist in a multi-system landscape. An organization can use different systems, of different types, to run the organization, for example. The browser providing systems (and/or asset provider systems) 106 can include systems from a same entity or different entities. The browser providing systems (and/or asset provider systems) 106 can each include at least one of an interface 114C, a processor 110C, a memory 112C, and a browser system 128. The browser system 128 can include an implementation of operations associated to authentication processes. For example, the browser system 128 can provide the user device 104 with access to data stored by the memory 112C needed for the authentication process. The data stored by the memory 112C needed for the authentication process can include API configurations 130A and SAH settings 130B. The API configurations 130A can define the API 126 of the user device 104 as being a gatekeeper API (e.g., a RESTful AP)I that facilitates extensive customization and integration with the server system 102 for the authentication process.

In some implementations, the network 108 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems. Data exchanged over the network 108, is transferred using any number of network layer protocols, such as Internet Protocol (IP), Multiprotocol Label Switching (MPLS), Asynchronous Transfer Mode (ATM), Frame Relay, etc. Furthermore, in implementations where the network 108 represents a combination of multiple sub-networks, different network layer protocols are used at each of the underlying sub-networks. In some implementations, the network 108 represents one or more interconnected internetworks, such as the public Internet.

Each processor 110A, 110B, 110C included in the examples system 100 can be a central processing unit (CPU), an application specific integrated circuit (ASIC), a field-programmable gate array (FPGA), or another suitable component. Each processor 110A, 110B, 110C included in the server system 102, the user device 104, and the browser providing system 106 executes instructions and manipulates data to perform the authentication operations for providing the user device 104 with access to multiple applications 120A. Each processor 110A, 110B, 110C can be a CPU, a blade, an ASIC, a FPGA, or another suitable component. Each processor 110A, 110B, 110C executes instructions and manipulates data to perform the operations of the respective system (the server system 102, the user device 104, and the browser providing system 106). Specifically, each processor 110A, 110B, 110C executes the functionality required to receive and respond to requests from the respective system (the server system 102, the user device 104, and the browser providing system 106), for example.

Interfaces 114A, 114B, 114C are used by the server system 102, the user device 104, and the browser providing system 106 respectively, for communicating with other systems in a distributed environment—including within the system 100—connected to the network 108. Generally, the interfaces 114A, 114B, 114C each include logic encoded in software and/or hardware in a suitable combination and operable to communicate with the network 108. More specifically, the interfaces 114A, 114B, 114C may each include software supporting one or more communication protocols associated with communications such that the network 108 or interface's hardware is operable to communicate physical signals within and outside of the illustrated system 100.

The memory 112A, 112B, 112C may include any type of memory or database module and may take the form of volatile and/or non-volatile memory including, without limitation, magnetic media, optical media, random access memory (RAM), read-only memory (ROM), removable media, or any other suitable local or remote memory component. The memory 112A, 112B, 112C may store various objects or data, including caches, classes, frameworks, applications, backup data, business objects, jobs, web pages, web page templates, database tables, database queries, repositories storing business and/or dynamic information, and any other appropriate information including any parameters, variables, algorithms, instructions, rules, constraints, or references thereto associated with the purposes of the server system 102, or the user device 104, respectively.

There can be any number of server systems 102, user devices 104, and the browser providing system 106 associated with, or external to, the system 100. Additionally, the example system 100 can include one or more additional user devices external to the illustrated portion of system 100 that are capable of interacting with the system 100 via the network(s) 108. Further, the term “client,” “user device,” and “user” can be used interchangeably as appropriate without departing from the scope of the disclosure. Moreover, while user device can be described in terms of being used by a single user, the disclosure contemplates that many users may use one computer, or that one user may use multiple computers. As used in the present disclosure, the term “computer” is intended to encompass any suitable processing device. For example, although FIG. 1 illustrates a single server system 102, a single user device 104, the system 100 can be implemented using a single, stand-alone computing device, two or more servers 102, or multiple user devices. The server system 102, and the user device 104 may include any computer or processing device such as, for example, a blade server, general-purpose personal computer (PC), Mac®, workstation, UNIX-based workstation, or any other suitable device. In other words, the present disclosure contemplates computers other than general purpose computers, as well as computers without conventional operating systems. Further, the server system 102 and the user device 104 can be adapted to execute any operating system or runtime environment, including Linux, UNIX, Windows, Mac OS®, Java™, Android™, iOS, BSD (Berkeley Software Distribution) or any other suitable operating system. According to one implementation, the server system 102 may also include or be communicably coupled with an e-mail server, a Web server, a caching server, a streaming data server, and/or another suitable server.

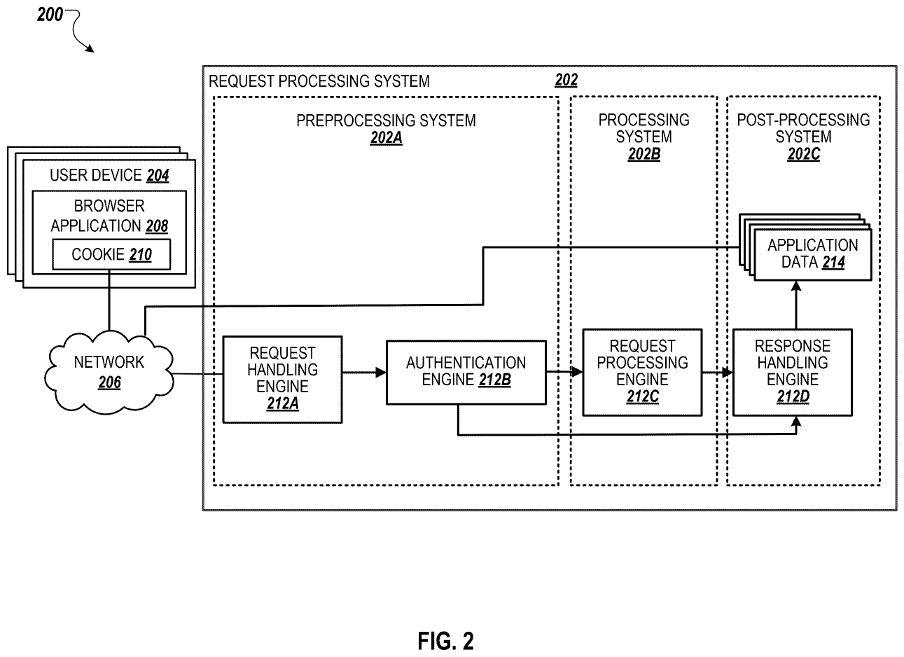

Regardless of the particular implementation, “software” may include computer-readable instructions, firmware, wired and/or programmed hardware, or any combination thereof on a tangible medium (transitory or non-transitory, as appropriate) operable when executed to perform at least the processes and operations described herein. Indeed, each software component can be fully or partially written or described in any appropriate computer language including C, C++, Java™, JavaScript®, Visual Basic, assembler, Perl®, ABAP (Advanced Business Application Programming), ABAP OO (Object Oriented), any suitable version of 4GL, as well as others. While portions of the software illustrated in FIG. 1 are shown as individual modules that implement the various features and functionality through various objects, methods, or other processes, the software may instead include multiple sub-modules, third-party services, components, libraries, and such, as appropriate. Conversely, the features and functionality of various components can be combined into single components as appropriate. The communication between the server system 102, the end user device 104 and the browser providing system 106 can include several different communication protocols configured to optimize handling cookies for single sign-on sessions, as further described in detail with reference to FIGS. 2-4

FIG. 2 is a block diagram of an example system architecture 200 for handling cookies for session requests, according to some implementations of the disclosure. The illustrated example system architecture 200 includes or is communicably coupled with an request processing system 202 and a user device 204. The request processing system 202 (e.g., request processing system 116 described with reference to FIG. 1) can be included in a server system (e.g., server system 102 described with reference to FIG. 1). Although shown separately, in some implementations, the request processing system 202 can be included in any of the user device 204 (e.g., user device 104 described with reference to FIG. 1), a browser providing system (e.g., browser providing system 106 described with reference to FIG. 1), or can be communicatively coupled over a network 206 (e.g., network 108 described with reference to FIG. 1) to any of the user device 204, the browser providing system 208, and an application provider system (e.g., server system 102 described with reference to FIG. 1).

The user device 204 can include applications 208, such as web browsers and/or native applications, to facilitate handling cookies 210 for session requests (e.g., single sign-on sessions) to access applications provided as services. A native browser application 208 is an application developed for a particular platform or a particular device (e.g., mobile devices having a particular operating system). Although operations may be described as being performed by the user device 204, such operations may be performed by a browser application 208 running on the user device 204. The applications 208 can present electronic resources, e.g., web pages, application pages, or other application content, to a user of the user device 204. The electronic resources can include digital component slots for presenting digital components with the content of the electronic resources. A digital component slot is an area of an electronic resource (e.g., web page or application page) for displaying a digital component. A digital component slot can also refer to a portion of an audio and/or video stream (which is another example of an electronic resource) for playing a digital component.

An electronic resource is also referred to herein as a resource for brevity. For the purposes of the document, a resource can refer to a web page, application page, application content presented by a native application, electronic document, audio stream, video stream, or other appropriate type of electronic resource with which a digital component can be presented. As used throughout the document, the phrase “digital component” refers to a discrete unit of digital content or digital information (e.g., a video clip, audio clip, multimedia clip, image, text, or another unit of content). A digital component can electronically be stored in a physical memory device as a single file or in a collection of files, and digital components can take the form of video files, audio files, multimedia files, image files, or text files and include advertising information, such that an interaction is a type of digital component. For example, the digital component may be content that is intended to supplement content of a web page or other resource presented by the browser application 208. More specifically, the digital component may include digital content that is relevant to the resource content (e.g., the digital component may relate to the same topic as the web page content, or to a related topic). The provision of digital components can supplement, and generally enhance, the web page or application content.

In response to the browser application 208 loading a resource that includes a digital component slot, the browser application 208 can generate a request (e.g., an authentication request) that requests handling of cookies 210 to facilitate access of multiple applications during a single sign on session. In some implementations, the digital component slot and/or the resource can include code (e.g., scripts) that cause the browser application 208 to request the request processing system 202 to process the cookies 210. In some implementations, the request can include a storage access header and contextual data, defining applications intended to be accessed by the user device 204. The storage access header can describe storage access permissions enabled by the browser application 208.

The request processing system 202 can include a preprocessing system 202A, a processing system 202B, and a post processing system 202C. The request processing system 202 can be implemented using one or more server computers (or other appropriate computing devices), that may be distributed across multiple locations. In general, the request processing system 202 receives requests for handling cookies 210, for an authentication session, from user devices 204. In some implementations, the request processing system 202 can be operated and maintained by an independent trusted party, e.g., a party that is different from the users of the user devices, the parties that operate supply side platform (SSP) and demand side platforms (DSPs), and the digital component providers, to ensure security and privacy with respect to the data.

The preprocessing system 202A can include a request handling engine 212A and an authentication engine 212B. The preprocessing system 202A can receive and preprocess the request with its headers. For example, the request handling engine 212A can include filtering components (filters) to execute an initial filtering of the request and the respective headers. The filtering process can be independent of the application requested by the user device 204 to be accessed. The authentication engine 212B receives, from the request handling engine 212A, the filtered request and handles authentication (policy decision point). For example, the authentication engine 212B selects CHIPS mode or SAH mode for cookie handling appropriate to the received request, based on the storage access permissions of the browser application 208. In some implementations, the request handling engine 212A can select a protocol with the CHIPS mode, a SAH mode, or a CHIPS Auto Mode, covering both use cases (iFrame and non-iFrame). To prevent user device modifications, the request handling engine 212A executes a dynamic mechanism that automatically selects the optimal approach (e.g., respond according to the SAH protocol to grant access or continue with CHIPS Auto Mode and partition the cookie). The request handling engine 212A can execute a process according to the following pseudo code.

For incoming request:
//Extract relevant headers and parameters
let secFetchStorageAccess=request.headers[‘Sec-Fetch-Storage-Access’];]
let secFetchMode=request.headers[‘Sec-Fetch-Mode’];]
let sessionCookie=request.cookies.contains(‘session’);)
If secFetchStorageAccess==‘inactive’and:
If not sessionCookie and secFetchMode!=‘navigate’:
//No session cookie and not a navigation request: use SAH protocol
response.headers[‘Activate-Storage-Access’]=‘retry’;
response.body=‘Storage access required. Please retry.’;
response.status=401//Unauthorized
return
Else:
//Continue processing request with CHIPS Auto Mode
If CHIPS_AUTO_MODE_RESPONSE_HANDLER is active
EndIf.

The request handling engine 212A can determine that SAH Auto Mode is not sufficient to satisfy one or more request cases (e.g. clients want to leverage SAH for optimizing performance). The SAH protocol mode can be applied to iFrame-based scenarios used to embed external content within a web page generated by the browser application 208, which are assumed to include Sec-Fetch-Mode header with value ‘navigate’. Note that in iFrame scenarios, the SAH protocol specifies responding with ‘LOAD’ instead of ‘RETRY’ to instructs the browser to reload the iFrame, with an active permission. Fetch mode equals ‘navigate’ indicates that it is an iFrame scenario. To overcome limitations with SAH Auto Mode, an option for applications to manually enable SAH, overriding the described “auto mode.” The server can additionally evaluate a new URL parameter “enableSAH” and implement the following algorithm.

For incoming request:
//Extract relevant headers and parameters
let secFetchStorageAccess=request.headers[‘Sec-Fetch-Storage-Access’];
let secFetchMode=request.headers[‘Sec-Fetch-Mode’];
let sessionCookie=request.cookies.contains(‘session’);
let enableSAH=request.params[‘enableSAH’];
//Decision-making based on storage access and headers
if enableSAH==‘true’ and secFetchStorageAccess==‘inactive’ and secFetchMode==‘navigate’ and not sessionCookie:
//Enable Storage Access Headers (SAH) protocol
response.headers[‘Activate-Storage-Access’]=‘load‘;
response.body=‘Activate storage access and load.’;
response.status=401; //Unauthorized
return; / Skip the subsequent Request Processing and Post Processing Stages
endif
//Continue with subsequent request handler components (Pre-Processing Stage).

The request handling engine 212A can be configured to combine the processing mode for (conditional) storage access header auto mode for non-iframe use cases and (conditional) manual SAH override using the following example pseudo code.

For incoming request:
//Extract necessary headers and parameters
let secFetchStorageAccess=request.headers[‘Sec-Fetch-Storage-Access’];
let secFetchMode=request.headers[‘Sec-Fetch-Mode’];
let sessionCookie=request.cookies.contains(‘session’);
let enableSAH=request.params[‘enableSAH’];
if secFetchStorageAccess==‘inactive’ and not sessionCookie:
//Manual SAH Override for iFrame scenarios
if enableSAH==‘true’ and secFetchMode==‘navigate’:
//Reply with ‘Activate-Storage-Access: load’
response.headers[‘Activate-Storage-Access’]=‘load’;
response.body=‘Activate storage access and load.’;
response.status=401; //Unauthorized
return; //Skip the subsequent Request Processing and Post Processing Stages
//SAH Auto Mode for non-iFrame scenarios
elseif secFetchMode!=‘navigate’:
//No session cookie and not a navigation request: use SAH protocol
response.headers[‘Activate-Storage-Access’]=‘retry’;
response.body=‘Storage access required. Please retry.’;
response.status=401; //Unauthorized
return; //Skip the subsequent Request Processing and Post Processing Stages
end if
end if
//Continue with subsequent request handler components (Pre-Processing Stage).

The processing system 202B can include a request processing engine 212C. The processing system 202B can execute the request processes corresponding to the selected mode for cookie handling and generate the response. The request processing engine 212C can add application-specific cookie headers.

The post processing system 202C can include a response handling engine 212D. The post processing system 202C can execute post processing operations using the request and the response with the respective headers (including cookies). Response handling engine components (filters) can modify the response headers. For streaming Web Servers, the response handling engine 212D can adjust the response. The response handling engine 212D can add generic authentication cookies during application-independent post-processing. The post processing system 202C can execute post processing operations using the CHIPS auto mode to ensure that cookies are only partitioned if the browser application 208 indicates a lack of storage access. The post processing can include header and cookie extraction, decision making based on header information, condition verification, and cookie modification with the specified attributes based on the storage access status, enhancing security and privacy by controlling how cookies are partitioned and accessed. A new Sec-Fetch-Storage-Access attribute of an inactive header is leveraged to indicate that unpartitioned cookie access is available but not in use. Implementation is done in the post-processing stage by adding a response handling engine component with the following logic. Depending on the values of the Sec-Fetch-Storage-Access header, the service can set cookies (for an inactive case) by setting cookie attributes (e.g., Partitioned and SameSite=None) or otherwise (for an active case or for an absent header) by setting unpartitioned cookies (using an assumption that the browser in these cases has storage access). The setting of cookie attributes requires a response handling engine implementing the logic indicated by the following pseudo code. The absence of the Sec-Fetch-Storage-Access header does not exclusively indicate that the storage access API (SAH) is unsupported. The header can be omitted in top-level usage scenarios to indicate that storage access is already available.

Pseudo Code:
For outgoing response:
//Extract relevant headers from the request
let secFetchStorageAccess=request.headers[‘Sec-Fetch-Storage-Access’]
//Extract existing cookies from the response
let cookies=response.headers[‘Set-Cookie’]
//Decision-making based on Sec-Fetch-Storage-Access header
If secFetchStorageAccess==‘none’ OR secFetchStorageAccess==‘inactive’:
//Modify each cookie to include Partitioned and SameSite=None
for each cookie in cookies:
//Modify the cookie with desired attributes
modifiedCookie=modifyCookie(cookie, {
‘SameSite’: ‘None’,
‘Partitioned’: True
})
//Update cookie in the response
response.headers[‘Set-Cookie’].replace(cookie, modifiedCookie)
EndFor
Else:
//Ensure cookies are unpartitioned
for each cookie in cookies:
//Modify the cookie to removeexclude Partitioned attribute
modifiedCookie=modifyCookie(cookie, {
‘Partitioned’: False
})
//Update cookie in the response
response.headers[‘Set-Cookie’].replace(cookie, modifiedCookie)
EndFor
EndIf.

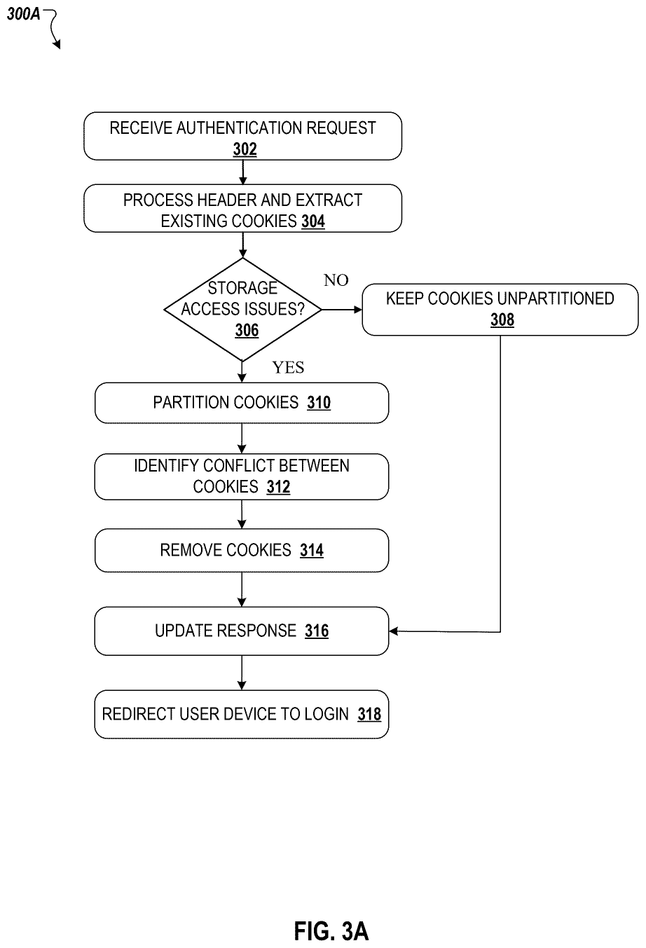

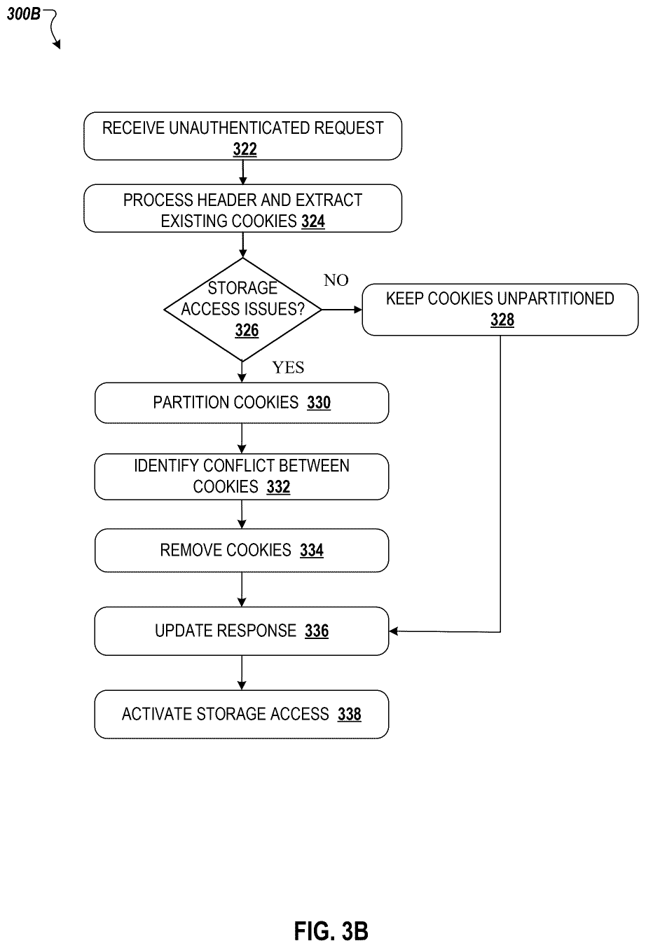

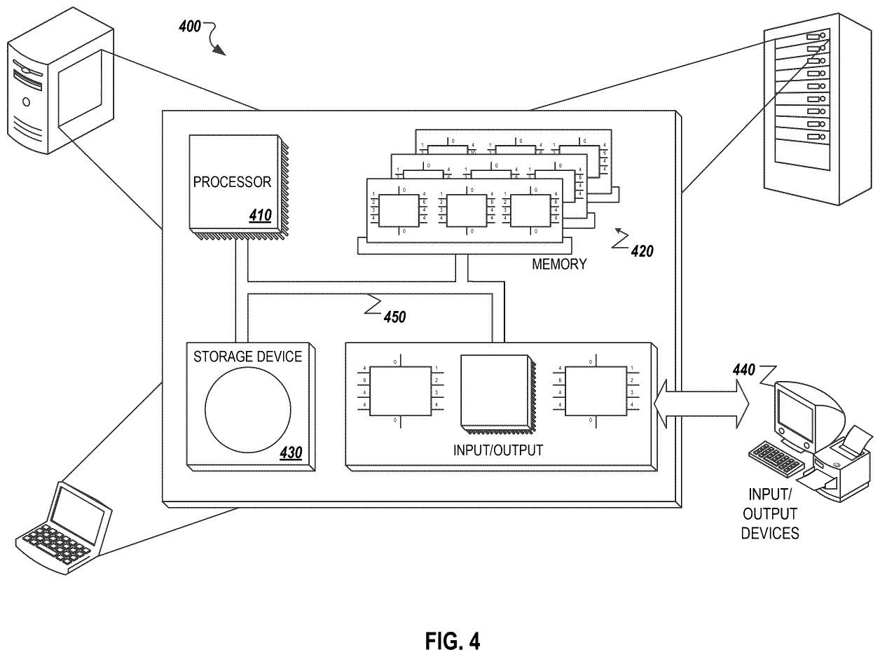

FIG. 3A is a flowchart of an example process 300A for handling cookies for single sign-on sessions, according to some implementations of the present disclosure. The example process 300A can be performed by any component of the example system 100, described with reference to FIG. 1 or the example system architecture 200, described with reference to FIG. 2 or the example computing system 400, described with reference to FIG. 4. For clarity of presentation, the description that follows describes the example process 300A in the context of the systems described with reference to FIGS. 1, 2, and 4.

At 302, an authentication request to access applications provided as a service during a single sign on session is received, by one or more processors. The authentication request includes a cookie processing request for cookies corresponding to the single sign on session. The authentication request can be entered through a browser application.

At 304, a storage access header of the authentication request is processed to extract a header and existing cookies, by one or more processors. The storage access header includes storage access permissions of a browser application (e.g., browser application 208, described with reference to FIG. 2). A cookie processing mode is selected, between the CHIPS and SAH election mode, based on the storage access permissions of a browser application, as indicated by the storage access header. The CHIPS Auto Mode is elected, facilitating partitioning of cookies, if the browser application indicates a lack of storage access. The SAH mode can be elected for non-iframe use cases. A web dispatcher can serve a static content (e.g., CSS files) or allow access to Web APIs. Authentication can be enabled using a session cookie, which can be included in requests to the resources (API/CSS/files in general). For example, a document that includes an image can be accessible at a different (unrelated) site, using the user's credentials (e.g., unpartitioned cookies). SAH can be used only for the session cookie (typically called JSESSIONID), which is used for authenticating cross-site fetch requests. Applications can ensure that the respective cookie is not partitioned. If an application needs storage access permission to the appropriate <site, site> pair (e.g., via an iframe at some point in the recent past), the described case is supported by the browser application. In some implementations, a process combines a protocol with the CHIPS Auto Mode, covering both use cases (iFrame and non-iFrame). To prevent user device modifications, the process includes a dynamic mechanism that selects the optimal approach automatically (e.g., respond according to the SAH protocol to grant access or continue with CHIPS Auto Mode and partition the cookie). The process can be implemented by a request handling engine component in the pre-processing stage.

At 306, it is determined, by the one or more processors, whether one or more storage access issues related to the cookies preventing cross-application tracking exist. Determining, from the storage access permissions, storage access issues includes determining that unpartitioned cookies are inaccessible to a fetch context lacking the storage access permissions; or determining that the fetch context comprises the storage access permissions and is missing an access path to the unpartitioned cookies. The conflict between the new partitioned cookies and the previously stored cookies includes an endless login loop. In some implementations, with CHIPS Auto Mode enabled, stale cookies can be inadvertently created by toggling third-party cookie blocking on and off. The action stale cookie creation can impact both partitioned and unpartitioned cookies. To prevent potential issues, the one or more processors can clean up both types of cookies, or verify that the server system can handle duplicate cookies with different values and select the correct cookie.

At 308, and response to determining that no storage access issues exist or that that the server system can handle duplicate cookies with different values and select the correct cookie, unpartitioned cookies are kept, by the one or more processors and a response to the user device can be updated and transmitted.

At 310, in response to determining, by the one or more processors, that storage access issues exist, a clean-up process can be executed. The clean-up process matches the selected cookie handling mode. The clean-up process can depend on particular authentication or cookie handling methods. The clean-up process can include partitioning cookies if needed (no storage access), not partitioning cookies if not needed (storage access available), and maintaining unpartitioned cookies and following the SAH protocol. If no storage access, cookies are partitioned, by the one or more processors, to generate new partitioned cookies for activating storage access. The clean-up process can be executed using a network communication tool bridging connections between the server system and the browser providing system (e.g., ABAP Web Dispatcher) and serving as an entry point for the requests. In some implementations, the clean-up process can be limited to cleaning up particular cookie types, such as the session cookie. The clean-up process can be executed using a request handling engine, which can be added in the request handling engine chain. The request handling engine can be configured to create a new cookie while expiring the existing old cookie by sending a “clean-up cookie,” to delete all duplicate cookies, assuming that the duplicate cookies include the session cookie and that the deletion of the duplicate cookies can cause the user device and the server system to reinitiate the authentication process. The request handling engine can be configured to execute a process similar to the following pseudo code:
For incoming request:
//Extract relevant headers from the request
let cookies=request.headers[‘Cookie’];
let duplicateCookies=findDuplicateCookies(cookies);
if duplicateCookies.length>0:
//Ensure ‘Set-Cookie’ header exists and is initialized as an array
response.headers[‘Set-Cookie’]=response.headers[‘Set-Cookie’]∥[];
//Handle duplicate cookies
for each duplicateCookie in duplicateCookies:
//Modify the duplicate cookie to create “clean-up cookies”
let cleanUpCookies=modifyToCleanUpCookies(duplicateCookie);
//Update the response header to include the clean-up cookies
for each cleanUpCookie in cleanUpCookies:
response.headers[‘Set-Cookie’].push(cleanUpCookie);
end for
end for
//Redirect to self
response.status=307; //HTTP status code for redirection
response.headers[‘Location’]=request.url; //Redirect to the same URL
response.body=‘Redirecting due to duplicate cookies’;
//Define a helper functionStages
end if
//Helper functions
//Function to modify the cookie string to create
//two “clean-up cookies” for deletion: one with and one without partitioned attribute
function modifyToCleanUpCookies(cookie) {
//Extract the cookie name
let cookieNameValuePair=cookie.split(‘=’); //Assuming the format is name=value
let cookieName=cookieNameValuePair[0];
//Create the base “clean-up cookie” string
let cleanUpCookieBase=cookieName+‘=−1; HttpOnly; SameSite=None; Secure; Max-Age=0’;
//Generate two clean-up cookies: ‘Partitioned’ and not partitioned
let cleanUpCookies=[
cleanUpCookieBase,
cleanUpCookieBase+‘; Partitioned’
];
return cleanUpCookies;
}
//Check for duplicate cookies with the same name but different values
function findDuplicateCookies(cookies) {. . . } //straight-forward logic
//Main logic for COOKIE_CLEANUP_REQUEST_HANDLING ENGINE
if (duplicateCookies.length>0) {
for each (let duplicateCookie in duplicateCookies) {
//Modify the duplicate cookie to create “clean-up cookies”
for each (let cleanUpCookie in cleanUpCookies) {
}
}
response.status=302; //HTTP status code for redirection
response.headers[‘Location’]=request.url; //Redirect to the same URL
return;
}.

At 312, a conflict between the new partitioned cookies and previously stored cookies is identified, by the one or more processors. The previously stored cookies can include previously partitioned cookies or previously unpartitioned cookies. The previously partitioned cookies and previously unpartitioned cookies can include same names.

At 314, the previously stored cookies are removed, by the one or more processors to resolve the conflict. Cookie removal can include deleting the selected previously stored cookies, using a set clean-up procedure.

At 316, a response to the authentication request to access the applications, using the new partitioned cookies is provided, by the one or more processors. The response can be generated by a response handling engine, as described with reference to FIG. 2. The response can include an approval to access the requested application (without requiring additional authentication information). In some implementations, a “clean-up cookie” is sent with every response. Within the context example of executing the CHIPS Auto Mode, in response to partitioning a cookie, an unpartitioned clean-up cookie can be sent, using a response handling engine instead of a request handling engine.

At 318, the user device is redirected to login, by the one or more processors, to automatically reinitiate the authentication process and enable access to the requested applications without issues. In response to determining that no new issues are detected and a successful access of the applications during the single sign on session is completed, the new partitioned cookies are deleted.

The example process 300A for handling cookies for single sign-on sessions provides several significant advantages for efficiently accessing multiple applications during an authentication session. By including a clean-up procedure that uses the same cookie name for both partitioned and unpartitioned cookies, the example process 300A ensures compatibility and increases the data processing efficiency. The described partitioning is applied only if needed based on the new Sec-Fetch-Storage-Access header, leading to an improved cookie management for the single sign-on sessions. The example process 300A advantageously includes a dynamic handling of the SAH protocol, optimizing resource utilization and further enhancing the effectiveness of cookie management. The example process 300A optimizes cookie handling based on a selection of an operation mode dependent on header extracted information generating a seamless application access experience for the user devices.

FIG. 3B is a flowchart of an example process 300B for handling cookies for unauthenticated requests, according to some implementations of the present disclosure. The example process 300B can be performed by any component of the example system 100, described with reference to FIG. 1 or the example system architecture 200, described with reference to FIG. 2 or the example computing system 400, described with reference to FIG. 4. For clarity of presentation, the description that follows describes the example process 300B in the context of the systems described with reference to FIGS. 1, 2, and 4.

At 322, an unauthenticated request to access applications provided as a service is received, by one or more processors. The unauthenticated request includes a cookie processing request for cookies corresponding to the single sign on session. The unauthenticated request can be entered through a browser application.

At 324, a storage access header of the unauthenticated request is processed to extract a header and existing cookies, by one or more processors. The storage access header includes storage access permissions of a browser application (e.g., browser application 208, described with reference to FIG. 2). A cookie processing mode is selected, between the CHIPS and SAH election mode, based on the storage access permissions of a browser application, as indicated by the storage access header. The CHIPS Auto Mode is elected, facilitating partitioning of cookies, if the browser application indicates a lack of storage access. The SAH mode can be elected for non-iframe use cases. A web dispatcher can serve a static content (e.g., CSS files) or allow access to Web APIs. Applications can ensure that the respective cookie is not partitioned. If an application needs storage access permission to the appropriate <site, site>pair (e.g., via an iframe at some point in the recent past), the described case is supported by the browser application. In some implementations, a process combines a protocol with the CHIPS Auto Mode, covering both use cases (iFrame and non-iFrame). To prevent user device modifications, the process includes a dynamic mechanism that selects the optimal approach automatically (e.g., respond according to the SAH protocol to grant access or continue with CHIPS Auto Mode and partition the cookie). The process can be implemented by a request handling engine component in the pre-processing stage.

At 326, it is determined, by the one or more processors, whether one or more storage access issues related to the cookies preventing cross-application tracking exist. Determining, from the storage access permissions, storage access issues includes determining that unpartitioned cookies are inaccessible to a fetch context lacking the storage access permissions; or determining that the fetch context comprises the storage access permissions and is missing an access path to the unpartitioned cookies. In some implementations, with CHIPS Auto Mode enabled, stale cookies can be inadvertently created by toggling third-party cookie blocking on and off. The action stale cookie creation can impact both partitioned and unpartitioned cookies. To prevent potential issues, the one or more processors can clean up both types of cookies, or verify that the server system can handle duplicate cookies with different values and select the correct cookie.

At 328, and response to determining that no storage access issues exist or that that the server system can handle duplicate cookies with different values and select the correct cookie, unpartitioned cookies are kept, by the one or more processors and a response to the user device can be updated and transmitted.

At 330, in response to determining, by the one or more processors, that storage access issues exist, a clean-up process can be executed. The clean-up process matches the selected cookie handling mode. The clean-up process can depend on particular cookie handling methods. The clean-up process can include partitioning cookies if needed (no storage access), not partitioning cookies if not needed (storage access available), and maintaining unpartitioned cookies and following the SAH protocol. If no storage access, cookies are partitioned, by the one or more processors, to generate new partitioned cookies for activating storage access. The clean-up process can be executed using a network communication tool bridging connections between the server system and the browser providing system (e.g., ABAP Web Dispatcher) and serving as an entry point for the requests. In some implementations, the clean-up process can be limited to cleaning up particular cookie types, such as the session cookie. The clean-up process can be executed using a request handling engine, which can be added in the request handling engine chain. The request handling engine can be configured to create a new cookie while expiring the existing old cookie by sending a “clean-up cookie,” to delete all duplicate cookies, assuming that the duplicate cookies include the session cookie and that the deletion of the duplicate cookies can cause the user device and the server system to reinitiate the request processing process.

At 332, a conflict between the new partitioned cookies and previously stored cookies is identified, by the one or more processors. The previously stored cookies can include previously partitioned cookies or previously unpartitioned cookies. The previously partitioned cookies and previously unpartitioned cookies can include same names.

At 334, the previously stored cookies are removed, by the one or more processors to resolve the conflict. Cookie removal can include deleting the selected previously stored cookies, using a set clean-up procedure.

At 336, a response to the unauthenticated request to access the applications, using the new partitioned cookies is provided, by the one or more processors. The response can be generated by a response handling engine, as described with reference to FIG. 2. The response can include an approval to access the requested application (without requiring additional information). In some implementations, a “clean-up cookie” is sent with every response. Within the context example of executing the CHIPS Auto Mode, in response to partitioning a cookie, an unpartitioned clean-up cookie can be sent, using a response handling engine instead of a request handling engine.

At 338, the user device is provided with storage access that is activated, by the one or more processors, to process the request and to enable access to the requested applications without issues. For example, the application can expect other cookies to be sent with the cross-origin fetch/load request. If unrestricted access is requested, the SAH protocol can be used to activate storage access. The SAH auto mode is compatible with the example process 320B, under some conditions: if secFetchStorageAccess is ‘inactive,’ not sessionCookie, and secFetchMode! can be set to ‘navigate’ for an unauthenticated request that excludes a session cookie, to return “REPLY.“ The browser can activate storage access and can triggers the request again, now with secFetchStorageAccess set to ‘active.’ The condition does not restrict processing of the request that includes all cookies and is processed regularly.

The example process 300B for handling cookies for processing unauthenticated request provides several significant advantages for efficiently accessing multiple applications. The example process 300B is applicable to the case of an iFrame scenario, where storage access is obtained via a separate script running in an iFrame served from the same origin as the target page. The storage access header override can be used to activate storage access again after a reload/browser restart, the activation being limited to a set time interval. The example process 300B avoids reloading the script, decreasing process complexity. The example process 300B advantageously grants storage access to the available cookies, including session/authentication cookies, but also other data applicable to unauthenticated request scenarios. If the request is unauthenticated, a search for the SSO cookie and authentication can be skipped. A session cookie can be used during the execution of the example process 320B, for example when web servers access the session cookie for other features (e.g., session stickiness/session-based routing). cookie handling based on a selection of an operation mode dependent on header extracted information generating a seamless application access experience for the user devices.

FIG. 4 is a block diagram of an example computing system 400 used to provide computational functionalities associated with described algorithms, methods, functions, processes, flows, and procedures, for example, as described with reference to FIGS. 3A and 3B, according to some implementations of the present disclosure. As shown in FIG. 4, the computing system 400 can include a processor 410, a memory 420, a storage device 430, and input/output devices 440. The processor 410, the memory 420, the storage device 430, and the input/output devices 440 can be interconnected using a system bus 450. The processor 410 is capable of processing instructions for execution within the computing system 400. Such executed instructions can implement one or more components of, for example, the request processing system 116, 202, described with reference to FIGS. 1 and 2. In some implementations of the current subject matter, the processor 410 can be a single-threaded processor. Alternately, the processor 410 can be a multi-threaded processor. The processor 410 is capable of processing instructions stored in the memory 420 and/or on the storage device 430 to display graphical information for a user interface provided using the input/output device 440.

The memory 420 is a computer readable medium such as volatile or non-volatile that stores information within the computing system 400. The memory 420 can store data structures representing configuration object databases, for example. The storage device 430 is capable of providing persistent storage for the computing system 400. The storage device 430 can be a floppy disk device, a hard disk device, an optical disk device, or a tape device, or other suitable persistent storage means. The input/output device 440 provides input/output operations for the computing system 400. In some implementations of the current subject matter, the input/output device 440 includes a keyboard and/or pointing device. In various implementations, the input/output device 440 includes a display unit for displaying graphical user interfaces.

According to some implementations of the current subject matter, the input/output device 440 can provide input/output operations for a network device. For example, the input/output device 440 can include Ethernet ports or other networking ports to communicate with one or more wired and/or wireless networks (e.g., a LAN, a WAN, the Internet).

In some implementations of the current subject matter, the computing system 400 can be used to execute various interactive computer software applications that can be used for organization, analysis and/or storage of data in various (e.g., tabular) format (e.g., Microsoft Excel®, and/or any other type of software). Alternatively, the computing system 400 can be used to execute any type of software applications. These applications can be used to perform various functionalities, e.g., planning functionalities (e.g., generating, managing, editing of spreadsheet documents, word processing documents, and/or any other objects), computing functionalities, or communications functionalities. The applications can include various add-in functionalities (e.g., SAP Integrated Business Planning add-in for Microsoft Excel as part of the SAP Business Suite, as provided by SAP SE, Walldorf, Germany) or can be standalone computing products and/or functionalities. Upon activation within the applications, the functionalities can be used to generate the user interface provided using the input/output device 440. The user interface can be generated and presented to a user by the computing system 400 (e.g., on a computer screen monitor).

One or more aspects or features of the subject matter described herein can be realized in digital electronic circuitry, integrated circuitry, specially designed ASICs, FPGAs computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system can include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random-access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

The preceding figures and accompanying description illustrate example processes and computer implementable techniques. The environments and systems described above (or their software or other components) may contemplate using, implementing, or executing any suitable technique for performing these and other tasks. It will be understood that these processes are for illustration purposes only and that the described or similar techniques can be performed at any appropriate time, including concurrently, individually, in parallel, and/or in combination. In addition, many of the operations in these processes may take place simultaneously, concurrently, in parallel, and/or in different orders than as shown. Moreover, processes may have additional operations, fewer operations, and/or different operations, so long as the methods remain appropriate.

In other words, although the disclosure has been described in terms of certain implementations and generally associated methods, alterations and permutations of these implementations, and methods will be apparent to those skilled in the art. Accordingly, the above description of example implementations does not define or constrain the disclosure. Other changes, substitutions, and alterations are also possible without departing from the spirit and scope of the disclosure.

A number of implementations of the present disclosure have been described. Nevertheless, it will be understood that various modifications can be made without departing from the spirit and scope of the present disclosure. Accordingly, other implementations are within the scope of the following claims.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application.

Example 1. A computer-implemented method comprising: receiving an authentication request to access applications provided as a service during a single sign on session, the authentication request comprising a cookie processing request for cookies corresponding to the single sign on session; processing a storage access header of the authentication request, the storage access header comprising storage access permissions of a browser; determining, from the storage access permissions, storage access issues related to the cookies preventing cross-application tracking; partitioning the cookies, using a partition key, to generate new partitioned cookies for activating storage access; identifying a conflict between the new partitioned cookies and previously stored cookies; removing the previously stored cookies to resolve the conflict; and providing, a response to the authentication request to access the applications, using the new partitioned cookies.

Example 2. The computer-implemented method of any of the preceding examples, wherein determining, from the storage access permissions, storage access issues comprises: determining that unpartitioned cookies are inaccessible to a fetch context lacking the storage access permissions; or determining that the fetch context comprises the storage access permissions and is missing an access path to the unpartitioned cookies.

Example 3. The computer-implemented method of the preceding example, wherein the conflict between the new partitioned cookies and the previously stored cookies comprises an endless login loop.

Example 4. The computer-implemented method of any of the preceding examples, wherein the previously stored cookies comprise previously partitioned cookies or previously unpartitioned cookies.

Example 5. The computer-implemented method of any of the preceding examples, wherein the previously partitioned cookies and previously unpartitioned cookies comprise same names.

Example 6. The computer-implemented method of any of the preceding examples, wherein the previously stored cookies comprise stale cookies comprising an activated blocking status.

Example 7. The computer-implemented method of any of the preceding examples, comprising: in response to determining successful access the applications, deleting the new partitioned cookies.

Example 8. A computer-implemented system comprising: a computing device; and a computer-readable storage device coupled to the computing device and having instructions stored thereon which, when executed by the computing device, cause the computing device to perform operations for selectively generating graphical representations with digital assistants in enterprise systems, the operations comprising: receiving an authentication request to access applications provided as a service during a single sign on session, the authentication request comprising a cookie processing request for cookies corresponding to the single sign on session; processing a storage access header of the authentication request, the storage access header comprising storage access permissions of a browser; determining, from the storage access permissions, storage access issues related to the cookies preventing cross-application tracking; partitioning the cookies, using a partition key, to generate new partitioned cookies for activating storage access; identifying a conflict between the new partitioned cookies and previously stored cookies; removing the previously stored cookies to resolve the conflict; and providing, a response to the authentication request to access the applications, using the new partitioned cookies.

Example 9. The computer-implemented system of the preceding example, wherein determining, from the storage access permissions, storage access issues comprises: determining that unpartitioned cookies are inaccessible to a fetch context lacking the storage access permissions; or determining that the fetch context comprises the storage access permissions and is missing an access path to the unpartitioned cookies.

Example 10. The computer-implemented system of any of the preceding examples, wherein the conflict between the new partitioned cookies and the previously stored cookies comprises an endless login loop.

Example 11. The computer-implemented system of any of the preceding examples, wherein the previously stored cookies comprise previously partitioned cookies or previously unpartitioned cookies.

Example 12. The computer-implemented system of any of the preceding examples, wherein the previously partitioned cookies and previously unpartitioned cookies comprise same names.

Example 13. The computer-implemented system of any of the preceding examples, wherein the previously stored cookies comprise stale cookies comprising an activated blocking status.

Example 14. The computer-implemented system of any of the preceding examples, wherein the operations comprise: in response to determining successful access the applications, deleting the new partitioned cookies.

Example 15. A non-transitory computer-readable media encoded with a computer program, the computer program comprising instructions that when executed by one or more computers cause the one or more computers to perform operations comprising: receiving an authentication request to access applications provided as a service during a single sign on session, the authentication request comprising a cookie processing request for cookies corresponding to the single sign on session; processing a storage access header of the authentication request, the storage access header comprising storage access permissions of a browser; determining, from the storage access permissions, storage access issues related to the cookies preventing cross-application tracking; partitioning the cookies, using a partition key, to generate new partitioned cookies for activating storage access; identifying a conflict between the new partitioned cookies and previously stored cookies; removing the previously stored cookies to resolve the conflict; and providing, a response to the authentication request to access the applications, using the new partitioned cookies.

Example 16. The non-transitory computer-readable media of the preceding example, wherein determining, from the storage access permissions, storage access issues comprises: determining that unpartitioned cookies are inaccessible to a fetch context lacking the storage access permissions; or determining that the fetch context comprises the storage access permissions and is missing an access path to the unpartitioned cookies.

Example 17. The non-transitory computer-readable media of any of the preceding examples, wherein the conflict between the new partitioned cookies and the previously stored cookies comprises an endless login loop.

Example 18. The non-transitory computer-readable media of any of the preceding examples, wherein the previously stored cookies comprise previously partitioned cookies or previously unpartitioned cookies, wherein the previously partitioned cookies and previously unpartitioned cookies comprise same names.

Example 19. The non-transitory computer-readable media of any of the preceding examples, wherein the previously stored cookies comprise stale cookies comprising an activated blocking status.

Example 20. The non-transitory computer-readable media of any of the preceding examples, wherein the operations comprise: in response to determining successful access the applications, deleting the new partitioned cookies.

What is claimed is:

1. A computer-implemented method comprising:
receiving an authentication request to access applications provided as a service during a single sign on session, the authentication request comprising a cookie processing request for cookies corresponding to the single sign on session;
processing a storage access header of the authentication request, the storage access header comprising storage access permissions of a browser;
determining, from the storage access permissions, storage access issues related to the cookies preventing cross-application tracking;
partitioning the cookies, using a partition key, to generate new partitioned cookies for activating storage access;
identifying a conflict between the new partitioned cookies and previously stored cookies;
removing the previously stored cookies to resolve the conflict; and
providing, a response to the authentication request to access the applications, using the new partitioned cookies.

2. The computer-implemented method of claim 1, wherein determining, from the storage access permissions, storage access issues comprises:
determining that unpartitioned cookies are inaccessible to a fetch context lacking the storage access permissions; or
determining that the fetch context comprises the storage access permissions and is missing an access path to the unpartitioned cookies.

3. The computer-implemented method of claim 1, wherein the conflict between the new partitioned cookies and the previously stored cookies comprises an endless login loop.

4. The computer-implemented method of claim 1, wherein the previously stored cookies comprise previously partitioned cookies or previously unpartitioned cookies.

5. The computer-implemented method of claim 4, wherein the previously partitioned cookies and previously unpartitioned cookies comprise same names.

6. The computer-implemented method of claim 1, wherein the previously stored cookies comprise stale cookies comprising an activated blocking status.

7. The computer-implemented method of claim 1, comprising:
in response to determining successful access the applications, deleting the new partitioned cookies.

8. A computer-implemented system comprising:
a computing device; and
a computer-readable storage device coupled to the computing device and having instructions stored thereon which, when executed by the computing device, cause the computing device to perform operations for selectively generating graphical representations with digital assistants in enterprise systems, the operations comprising:
receiving an authentication request to access applications provided as a service during a single sign on session, the authentication request comprising a cookie processing request for cookies corresponding to the single sign on session;
processing a storage access header of the authentication request, the storage access header comprising storage access permissions of a browser;
determining, from the storage access permissions, storage access issues related to the cookies preventing cross-application tracking;
partitioning the cookies, using a partition key, to generate new partitioned cookies for activating storage access;
identifying a conflict between the new partitioned cookies and previously stored cookies;
removing the previously stored cookies to resolve the conflict; and
providing, a response to the authentication request to access the applications, using the new partitioned cookies.

9. The computer-implemented system of claim 8, wherein determining, from the storage access permissions, storage access issues comprises:
determining that unpartitioned cookies are inaccessible to a fetch context lacking the storage access permissions; or
determining that the fetch context comprises the storage access permissions and is missing an access path to the unpartitioned cookies.

10. The computer-implemented system of claim 8, wherein the conflict between the new partitioned cookies and the previously stored cookies comprises an endless login loop.

11. The computer-implemented system of claim 8, wherein the previously stored cookies comprise previously partitioned cookies or previously unpartitioned cookies.

12. The computer-implemented system of claim 11, wherein the previously partitioned cookies and previously unpartitioned cookies comprise same names.

13. The computer-implemented system of claim 8, wherein the previously stored cookies comprise stale cookies comprising an activated blocking status.

14. The computer-implemented system of claim 8, wherein the operations comprise:
in response to determining successful access the applications, deleting the new partitioned cookies.

15. A non-transitory computer-readable media encoded with a computer program, the computer program comprising instructions that when executed by one or more computers cause the one or more computers to perform operations comprising:
receiving an authentication request to access applications provided as a service during a single sign on session, the authentication request comprising a cookie processing request for cookies corresponding to the single sign on session;
processing a storage access header of the authentication request, the storage access header comprising storage access permissions of a browser;
determining, from the storage access permissions, storage access issues related to the cookies preventing cross-application tracking;
partitioning the cookies, using a partition key, to generate new partitioned cookies for activating storage access;
identifying a conflict between the new partitioned cookies and previously stored cookies;
removing the previously stored cookies to resolve the conflict; and
providing, a response to the authentication request to access the applications, using the new partitioned cookies.

16. The non-transitory computer-readable media of claim 15, wherein determining, from the storage access permissions, storage access issues comprises:
determining that unpartitioned cookies are inaccessible to a fetch context lacking the storage access permissions; or
determining that the fetch context comprises the storage access permissions and is missing an access path to the unpartitioned cookies.

17. The non-transitory computer-readable media of claim 15, wherein the conflict between the new partitioned cookies and the previously stored cookies comprises an endless login loop.

18. The non-transitory computer-readable media of claim 15, wherein the previously stored cookies comprise previously partitioned cookies or previously unpartitioned cookies, wherein the previously partitioned cookies and previously unpartitioned cookies comprise same names.

19. The non-transitory computer-readable media of claim 15, wherein the previously stored cookies comprise stale cookies comprising an activated blocking status.

20. The non-transitory computer-readable media of claim 15, wherein the operations comprise:
in response to determining successful access the applications, deleting the new partitioned cookies.
